(19) United States
(12) Patent Application Publication
(10) Pub. No.: US 2025/0203658 A1
(43) Pub. Date: Jun. 19, 2025

(54) COORDINATED SPATIAL REUSE IMPROVEMENT FOR WIRELESS COMMUNICATIONS

(71) Applicant: QUALCOMM Incorporated, San Diego, CA (US)

(72) Inventors: Kanke WU, San Diego, CA (US); Jialing Li CHEN, San Diego, CA (US); Bin TIAN, San Diego, CA (US); Sameer VERMANI, San Diego, CA (US)

(21) Appl. No.: 18/544,369

(22) Filed: Dec. 18, 2023

(51) Int. Cl. H04W 74/0816; H04B 17/336; H04W 8/22; H04W 52/36

(52) U.S. Cl. CPC H04W 74/0816; H04B 17/336; H04W 8/22; H04W 52/367

(57) ABSTRACT

This disclosure provides methods, components, devices and systems that may help various wireless devices perform coordinated spatial reuse in a wireless network. An example method, performed at a first wireless node, generally includes transmitting a first frame indicating a capability of the first wireless node to share a transmission opportunity (TXOP) with one or more candidate nodes. The method also includes transmitting a second frame (i) indicating that a first TXOP associated with the first wireless node is available to be shared with a group of the one or more candidate nodes and (ii) including one or more parameters that indicate one or more constraints on communication during the first TXOP. The method further includes participating in a coordinated transmission with the group of the one or more candidate nodes during the first TXOP using at least one of the one or more parameters.

### TECHNICAL FIELD

This disclosure relates generally to wireless communication, and more specifically, to techniques for coordinated spatial reuse operation in a wireless network.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

The systems, methods and devices of this disclosure each have several innovative aspects, no single one of which is solely responsible for the desirable attributes disclosed herein.

Certain aspects provide an apparatus for wireless communications. The apparatus generally includes memory including instructions, and at least one processor configured to execute the instructions to cause the apparatus to: output, for transmission to a first wireless node in a first basic service set (BSS), a first frame indicating a capability of the apparatus to share a transmission opportunity (TXOP) with one or more candidate nodes, wherein the one or more candidate nodes include the first wireless node and wherein the apparatus is associated with a second BSS different from the first BSS; output, for transmission to the first wireless node, a second frame indicating that a first TXOP associated with the apparatus is available to be shared with a group of the one or more candidate nodes, wherein the second frame further includes one or more parameters that indicate one or more constraints on communication during the first TXOP; and after the first frame and the second frame are outputted, participate in a coordinated transmission with the group of the one or more candidate nodes during the first TXOP using at least one of the one or more parameters.

Certain aspects provide an apparatus for wireless communications. The apparatus generally includes memory including instructions, and at least one processor configured to execute the instructions to cause the apparatus to: obtain, from a first wireless node in a first basic service set (BSS), a first frame indicating that a first transmission opportunity (TXOP) associated with the first wireless node is available to be shared with a group of one or more candidate nodes, wherein the one or more candidate nodes include the apparatus, wherein the apparatus is associated with a second BSS different from the first BSS, and wherein the first frame further includes one or more parameters that indicate one or more constraints on communication during the first TXOP; and after the first frame has been obtained, participate in a coordinated transmission with the first wireless node and the group of the one or more candidate nodes during the first TXOP using at least one of the one or more parameters.

Certain aspects provide a method for wireless communications at a first wireless node. The method generally includes outputting, for transmission to a second wireless node, a first frame indicating a capability of the first wireless node to share a transmission opportunity (TXOP) with one or more candidate nodes. The one or more candidate nodes include the second wireless node. The first wireless node is associated with a different basic service set (BSS) than the second wireless node. The method also includes outputting, for transmission to the second wireless node, a second frame indicating that a first TXOP associated with the first wireless node is available to be shared with a group of the one or more candidate nodes. The second frame further includes one or more parameters that indicate one or more constraints on communication during the first TXOP. The method further includes after outputting the first frame and the second frame, participating in a coordinated transmission with the group of the one or more candidate nodes during the first TXOP using at least one of the one or more parameters.

Certain aspects provide a method for wireless communications at a first wireless node. The method generally includes obtaining, from a second wireless node, a first frame indicating that a first transmission opportunity (TXOP) associated with the second wireless node is available to be shared with a group of one or more candidate nodes. The one or more candidate nodes include the first wireless node. The first wireless node is associated with different basic service set (BSS) than the second wireless node. The first frame further includes one or more parameters that indicate one or more constraints on communication during the first TXOP. The method also includes, after obtaining the first frame, participating in a coordinated transmission with the first wireless node and the group of the one or more candidate nodes during the first TXOP using at least one of the one or more parameters.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

The appended figures depict certain features of the various aspects described herein and are not to be considered limiting of the scope of this disclosure.

FIG. 1 shows a pictorial diagram of an example wireless communication network.

FIG. 2 shows an example communication protocol for coordinated spatial reuse operation.

FIG. 3 shows an example call flow diagram for coordinated spatial reuse operation, in accordance with aspects of the present disclosure.

FIG. 4 shows a flowchart illustrating an example process performable at a first wireless device for coordinated spatial reuse operation related to aspects of the present disclosure.

FIG. 5 shows a flowchart illustrating an example process performable at a second wireless device for coordinated spatial reuse operation related to aspects of the present disclosure.

FIG. 6 shows a block diagram of an example wireless communication device that supports aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Certain wireless systems may support spatial reuse (SR) operation, which generally involves a set of techniques for increasing the number of parallel transmissions among overlapping basic service sets (OBSSs) (e.g., a coordinated transmission) in order to increase spectral efficiency (e.g., utilization of a communication medium). Example SR techniques may include enhanced distributed channel access (EDCA) methods, OBSS packet detection (PD)-based SR methods, and parameterized spatial reuse (PSR) techniques, as illustrative, non-limiting examples.

One potential drawback to SR techniques is that there can be limited collaboration among BSSs in identifying an opportunity for a coordinated transmission. EDCA, for example, is a listen-before-talk (LBT) scheme that is based on energy detection and generally does not involve AP coordination. Likewise, in OBSS PD-based SR methods, each AP may perform signal detection independently to determine a coordinated transmission opportunity without cooperating with other APs. Similarly, in PSR techniques, APs may participate in trigger-based (TB) transmissions of another AP without coordination. Such lack of coordination among BSSs can impact the performance of the coordinated transmission in terms of reduced throughput, increased interference, and reduced signal strength, as illustrative, non-limiting examples.

To address these technical challenges associated with SR techniques, certain wireless systems may support coordinated spatial reuse (CSR) operation. Compared to SR operation, CSR operation generally involves a set of techniques that aim to increase the amount of AP coordination for a coordinated transmission. For example, in CSR operation, multiple APs may coordinate with each other (generally referred to herein as multiple AP (multi-AP) coordination) for one or more coordinated transmission opportunities using the same set of resources (e.g., frequency/time/spatial resources), thereby improving overall network throughput and performance relative to SR operation. For instance, CSR may allow for multi-AP coordination on aspects such as service period sharing, transmission opportunity (TXOP) sharing, participating AP/STA selection, transmit power coordination among participating AP/STAs, and interference coordination, as illustrative, non-limiting examples.

While CSR allows for improved multi-AP coordination, there are certain challenges presented when communicating with CSR. In certain CSR scenarios, for example, a coordinated transmission may occur that impacts the performance of certain participating AP/STAs, such as AP/STAs in poor coverage areas, AP/STAs that are experiencing high amounts of interference, etc. That is, the coordinated transmission may unfairly benefit one or more participating AP/STAs at the cost of performance of other participating AP/STAs, thereby degrading the overall network throughput and performance.

Aspects of the present disclosure provide techniques for improving CSR operation in a wireless communication network. As described in greater detail herein, certain aspects provide techniques that allow for ensuring coordinated transmissions are conducted with “fairness” to the participating AP/STAs, such that the performance of none of the participating AP/STA is unfairly compromised during the coordinated transmissions, where “fairness” is determined according to one or more performance metrics. Additionally, certain aspects described in greater detail herein provide techniques that allow for multi-AP coordination on identifying a coordinated service period (e.g., CSR-based service period), a coordinated transmission opportunity (e.g., CSR-based opportunity), or a combination thereof. In such aspects, for example, a TXOP holder can determine whether a coordinated transmission would be beneficial to one or more participating AP/STAs based on one or more criteria. Additionally, certain aspects described in greater detail herein provide techniques that allow for multi-AP coordination on determining which AP/STAs should participate in a given coordinated transmission or coordinated service period along with the level of coordination during the coordinated transmission or coordinated service period, based on one or more criteria.

Particular aspects of the subject matter described in this disclosure can be implemented to realize one or more of the following potential technical advantages. In some examples, the described techniques can be used to ensure that the performance of none of the participating AP/STAs in a given coordinated transmission is “unfairly” compromised. Additionally, the described techniques can be used to ensure that a coordinated transmission is performed when it is beneficial to the performance of the participating AP/STAs (e.g., in terms of one or more performance metrics). Further, the described techniques can be used to allow AP/STAs to negotiate on parameters on a given coordination transmission, such that the performance of the AP/STA is improved during the coordinated transmission. Accordingly, as a result of the techniques proposed herein, wireless systems may support CSR operation in a manner that helps improve overall system performance.

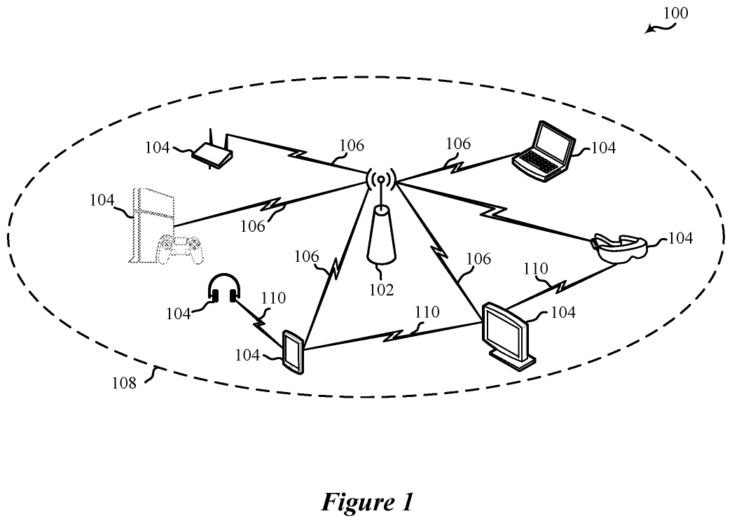

Note that while many of the examples depicted in FIGS. 1 to 6 describe various techniques for improving CSR operation for coordinated TXOPs, aspects of the present disclosure can be used to improve other aspects of CSR operation, such as service period sharing, as an illustrative, non-limiting example.

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad-hoc network (or wireless ad-hoc network). Ad-hoc networks may alternatively be referred to as mesh networks or peer-to-peer (P2P) networks. In some cases, ad-hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad-hoc system, one or more of the STAs 104 may assume the role filled by the AP 102 in a BSS. Such a STA 104 may be referred to as a group owner (GO) and may coordinate transmissions within the ad-hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 (e.g., WLAN) may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHz), FR3 (7.125 GHZ-24.25 GHZ), FR4a or FR4-1 (52.6 GHz-71 GHZ), FR4 (52.6 GHz-114.25 GHZ), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

In some examples, the AP 102 or the STAs 104 of the wireless communication network 100 (e.g., WLAN) may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (for example, High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log signal-to-noise ratio (SNR) trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHZ, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of wireless communication network 100 (e.g., WLAN) may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

Some APs and STAs may implement spatial reuse techniques. For example, APs and STAs configured for communications using IEEE 802.11ax or 802.11be may be configured with a BSS color. APs associated with different BSSs may be associated with different BSS colors. A BSS color is a numerical identifier of an AP's respective BSS (such as a 6 bit field carried by the SIG field). Each STA may learn its own BSS color upon association with the respective AP. BSS color information is communicated at both the PHY and MAC sublayers. If an AP or a STA detects, obtains, selects, or identifies, a wireless packet from another wireless communication device while contending for access, the AP or STA may apply different contention parameters in accordance with whether the wireless packet is transmitted by, or transmitted to, another wireless communication device within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP or STA, the AP or STA may use a first received signal strength indication (RSSI) detection threshold when performing a CCA on the wireless channel. However, if the BSS color associated with the wireless packet is different than the BSS color of the AP or STA, the AP or STA may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs may implement techniques for spatial reuse that involve participation in a coordinated communication scheme. According to such techniques, an AP may contend for access to a wireless medium to obtain control of the medium for a TXOP. The AP that wins the contention (hereinafter also referred to as a “sharing AP” or “sharing BSS”) may select one or more other APs (hereinafter also referred to as “shared APs” or “shared BSSs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP, The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional carrier-sense multiple access with collision avoidance (CSMA/CA) or EDCA techniques. Additionally, by enabling a group of APs associated with different BSSs to participate in a coordinated AP transmission session, during which the group of APs may share at least a portion of a single TXOP obtained by any one of the participating APs, such techniques may increase throughput across the BSSs associated with the participating APs and may also achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, an RX power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

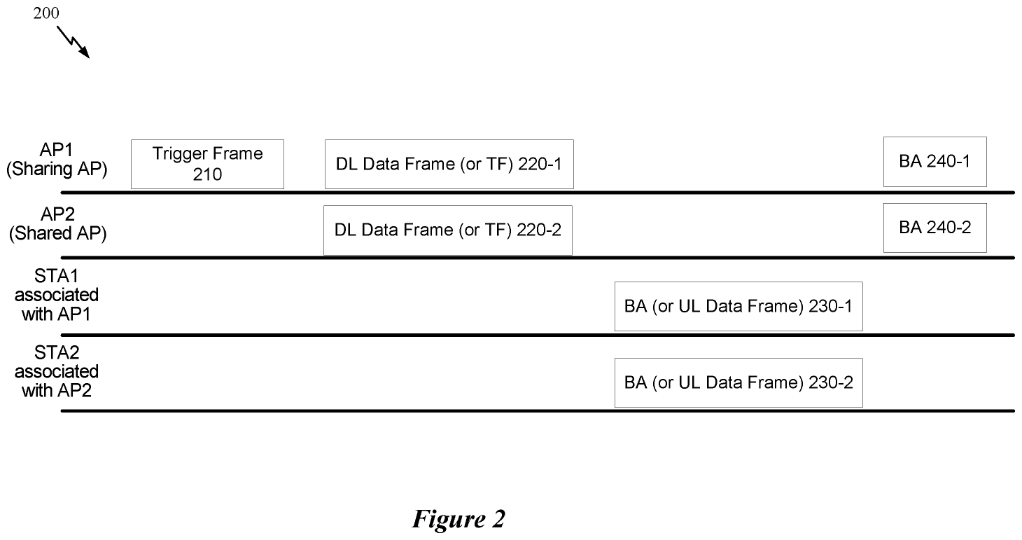

FIG. 2 illustrates an example communication protocol for coordinated spatial reuse (CSR) operation. As shown, AP1 (e.g., sharing AP) may initiate a CSR transmission by sending a trigger frame 210. In some cases, the AP1 may send the trigger frame 210 after successfully contending for the channel. The trigger frame 210 may be sent to AP2 (e.g., shared AP), which is in a different BSS than AP1. The trigger frame 210 may include various parameters associated with a subsequent coordinated transmission by AP1 and AP2. Such parameters, for example, may include a length of the coordinated transmission (e.g., PPDU length), transmit power of the sharing AP, target transmission power of the shared AP, and acceptable interference level of the serving STAs in the sharing BSS, as illustrative, non-limiting examples.

After receiving the trigger frame 210, AP2 may determine parameters of a downlink transmission, based in part on the trigger frame 210. Such parameters can include, for example, a STA identifier (e.g., STA2) to send downlink data to, a modulation and coding scheme (MCS), and transmit (or transmission) power, as illustrative, non-limiting examples. AP1 and AP2 may then perform a coordinated transmission (e.g., coordinated downlink data transmission). The coordinated transmission from AP1 and AP2 may use a same set of time/frequency/spatial resources (of the sharing AP). In some cases, the coordinated transmission from AP1 and AP2 may be synchronous or asynchronous in time and/or frequency. As shown, the coordinated transmission may involve AP1 sending a downlink data frame 220-1 to STA1 and AP2 sending a downlink data frame 220-2 to STA2. After receiving the downlink data frames 220-1 and 220-2, STA1 and STA2 may acknowledge the downlink data frames by sending respective acknowledgments 230-1 and 230-2 (e.g., block acknowledgements (BAs)).

In some implementations, instead of sending downlink data frames as part of the coordinated transmission, AP1 and AP2 may send trigger frames as part of the coordinated transmission, e.g., to trigger the transmission of uplink data frames from STA1 and STA2, respectively. In these implementations, after receiving the trigger frames, STA1 and STA2 may transmit uplink data frames to AP1 and AP2, respectively. The uplink data frames may be transmitted using a same set of time/frequency/spatial resources. After receiving the uplink data frames, AP1 and AP2 may acknowledge the uplink data frames by sending respective acknowledgements 240-1 and 240-2 (e.g., BAs).

### Aspects Related to Coordinated Spatial Reuse Improvement for Wireless Communications

Aspects of the present disclosure provide techniques for improving coordinated spatial reuse (CSR) operation in a wireless network.

As noted, in wireless systems that support CSR operation, there may be scenarios in which a coordinated transmission that occurs in the network negatively impacts the performance of one or more of the participating AP/STAs. For example, for AP/STAs in poor coverage areas and/or AP/STAs that are subjected to high amounts of interference, the coordinated transmission may unfairly benefit other participating AP/STAs at the cost of performance of the AP/STAs in poor coverage areas and/or AP/STAs being subjected to high amounts of interference.

Aspects of the present disclosure provide techniques that allow for AP/STAs to participate in coordinated transmissions, such that the performance of none of the participating AP/STAs is unfairly compromised during the coordinated transmission. More specifically, in certain aspects, a sharing AP may transmit a frame to at least one shared AP indicating that a TXOP associated with the sharing AP is available to be shared with the at least one shared AP. The frame may include one or more “fairness” parameters that indicate one or more constraints on communication during the service period of a non-AP STA or the TXOP. As described in greater detail herein, such “fairness” parameters may be throughput-based parameters, transmission power-based parameters, delay-based parameters, or a combination thereof.

Additionally, in certain aspects, sharing APs and shared APs may use techniques described herein to indicate support for coordinated transmissions, to determine whether the respective AP should participate in a coordinated transmission, to determine a level of coordination by the respective AP during the coordinated transmission, or a combination thereof.

Accordingly, as a result of the techniques proposed herein, the overall system performance may be improved (e.g., in terms of increased throughput, reduced latency, higher transmit power, etc.) in wireless systems that support CSR operation.

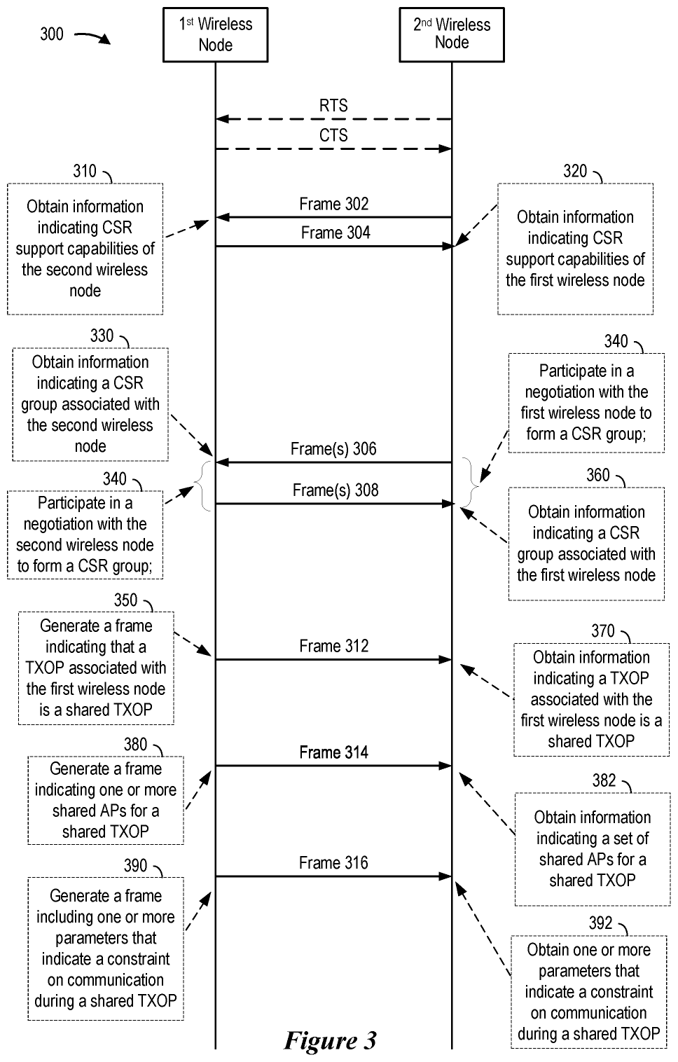

FIG. 3 depicts a call flow diagram 300 illustrating example signaling between wireless nodes for CSR operation, in accordance with certain aspects of the present disclosure.

In some aspects, the first wireless node and/or the second wireless node shown in FIG. 3 may be examples of the AP 102 depicted and described with respect to FIG. 1. For example, the first wireless node may be a sharing AP (associated with a sharing BSS) and the second wireless node may be a shared AP (associated with a shared BSS), or the first wireless node may be a shared AP and the second wireless node may be a sharing AP.

The sharing BSS (also referred to as a primary BSS) is the BSS of the TXOP holder (e.g., sharing AP). Transmissions that occur in the sharing BSS may be referred to as primary transmissions. On the other hand, the shared BSS (also referred to as a secondary BSS) is a BSS that transmits during a shared TXOP, excluding the sharing BSS. Transmissions that occur in a shared BSS may be referred to as secondary transmissions.

As indicated at 310, a first wireless node may obtain a frame 302 (from the second wireless node) that includes information on a capability of the second wireless node to support CSR operation. Similarly, as indicated at 320, the second wireless node may obtain a frame 304 (from the first wireless node) that includes information on a capability of the first wireless node to support CSR operation. In certain aspects, the frames 302 and 304 may be used by the first wireless node and second wireless node, respectively, to announce whether the wireless node supports CSR operation, whether the wireless node wants to participate in CSR operation, capabilities of the wireless node in CSR operation, or a combination thereof. For example, the capabilities of the wireless node indicated via the frames 302/304 may include an indication of a type of coordination (e.g., transmit power coordination, interference management coordination, channel state information (CSI)/channel quality information (CQI)/interference measurement coordination, etc.) supported during a coordinated transmission.

Note that while FIG. 3 depicts including information indicating CSR support capabilities within frames 302/304 (e.g., dedicated frames), in other aspects, such information may be included as part of a different frame (e.g., field/subfield of a beacon, part of a request-to-send (RTS)/clear-to-send (CTS) exchange, such as the RTS/CTS exchanged depicted in FIG. 3, etc.) and/or combined with other frames described and depicted in FIG. 3.

As indicated at 330, the first wireless node may obtain a frame 306 (from the second wireless node) that includes information indicating a CSR group associated with the second wireless node. For example, the CSR group indicated by the frame 306 may include a set of wireless nodes (e.g., participating APs, participating AP/STAs, etc.) including the second wireless node that have participated in prior coordinated transmissions and/or may participate in future coordinated transmissions. Similarly, as indicated at 360, the second wireless node may obtain a frame 308 (from the first wireless node) that includes information indicating a CSR group associated with the first wireless node. For example, the CSR group indicated by the frame 308 may include a set of wireless nodes (e.g., participating APs, participating AP/STAs, etc.) including the first wireless node that have participated in prior coordinated transmissions and/or may participate in future coordinated transmissions.

In certain aspects, the sharing AP and shared AP may negotiate and arrange a CSR group between themselves. Here, for example, as indicated at 340, the first wireless node and the second wireless node may participate in a negotiation with each other to form a CSR group. The negotiation may involve an exchange of one or more frames 306 and one or more frames 308 between the first wireless node and the second wireless node, as depicted in FIG. 3.

In certain aspects, the first wireless node and the second wireless node may use the negotiation (indicated at 340) to form a TXOP sharing agreement that involves a particular type of coordination during the shared TXOP. For example, the first wireless node and the second wireless node may agree to form a CSR group without power coordination and/or interference coordination. In such an example, assuming the first wireless node is the sharing AP, when the first wireless node announces that a TXOP is a shared TXOP, the second wireless node may be able to transmit during the shared TXOP (according to the negotiated agreement at 340) without any further coordination (e.g., no transmit power or interference coordination/constraints) between the first wireless node and the second wireless node. With this level of coordination during the shared TXOP (e.g., no power and/or interference coordination), the first wireless node may be able to dynamically decide if any given TXOP is a shared TXOP and which potential wireless nodes may become shared APs in the shared TXOP. For example, compared to PSR-based SR techniques, TXOP sharing without power/interference coordination may not be limited to TB-based transmissions (e.g., the TXOP holder can select and/or control the number of shared APs that participate in the shared TXOP).

In another example, the first wireless node and the second wireless node may agree to form a CSR group with power coordination and interference coordination, but without interference measurement coordination (e.g., joint interference measurement). In such an example, assuming the first wireless node is the sharing AP, the second wireless node's transmit power during the shared TXOP may be controlled by the first wireless node or may satisfy one or more conditions indicated by the first wireless node. Here, compared to PSR-based SR techniques, TXOP sharing with power/interference coordination but without interference measurement coordination may allow for the TXOP holder to select and/or control the number of shared APs that participate in the shared TXOP and their transmit powers.

In another example, the first wireless node and the second wireless node may agree to form a CSR group with power coordination, interference coordination, and interference measurement coordination (e.g., joint interference measurement). In such an example, assuming the first wireless node is the sharing AP, the first wireless node may perform joint sounding with the second wireless node. For instance, the first wireless node and the second wireless node may send a joint CSR sounding packet for interference measurement at a same time under this level of coordination. The joint CSR sounding packet may allow STAs associated with the first wireless node and the second wireless node that receive the joint CSR sounding packet to measure the interference level at the STAs. The STAs may then feedback information to their associated wireless node that can be used to determine whether a coordinated transmission can be supported. In some examples, the information may include an estimated signal-to-interference-and-noise ratio (SINR).

As indicated at 350, in certain aspects, assuming the first wireless node is a sharing AP, the first wireless node may generate and transmit a frame 312 indicating that a TXOP associated with the first wireless node is a shared TXOP. That is, the frame 312 may indicate that a TXOP associated with the first wireless node is available to be shared with at least the second wireless node (e.g., for a coordinated transmission). As indicated at 370, the second wireless node may obtain information from frame 312 indicating that a TXOP associated with the first wireless node is a shared TXOP. In certain aspects, the frame 312 may be used by the first wireless node to indicate that a TXOP is a shared TXOP and/or to dynamically turn on and off CSR operation.

In certain aspects, the first wireless node may determine whether to make a TXOP a shared TXOP based on pre-existing agreements with other wireless nodes, such as the second wireless node. For example, the first wireless node and the second wireless node may have previously agreed to share a certain number of TXOPs with each other. In another example, the first wireless node may have shared one of its TXOPs with the second wireless node in a previous transmission and may have previously negotiated that, in exchange for sharing one of its TXOPs, the second wireless node has to share an upcoming TXOP with the first wireless node.

In certain aspects, the first wireless node may determine whether to make a TXOP a shared TXOP based on at least one of an expected signal-to-noise ratio (SNR) at a third wireless node (e.g., STA) served by the first wireless node or an MCS intended for the third wireless node. For example, the first wireless node may determine to share its TXOP based on determining that the SNR at the third wireless node is higher than a threshold. In another example, the first wireless node may determine to share its TXOP based on determining that the MCS intended for the third wireless node is higher than a threshold.

In certain aspects, the first wireless node may determine whether to make a TXOP a shared TXOP based on an expected SINR at a third wireless node (e.g., STA) served by the first wireless node. In such aspects, the SINR may be estimated based on historical data or feedback information received from the third wireless node. For example, in general, the third wireless node may feedback information to the first wireless node that indicates the amount of interference the third wireless node is being subjected to from each OBSS AP. Such interference information may include at least one of: (i) observed interference level from neighboring BSSs, (ii) estimated signal-to-interference ratio (SIR) level (e.g., based on SNR and/or interference-to-noise ratio (INR) measurements), (iii) estimated SINR level (e.g., when a joint CSR sounding test ins performed), or (iv) a combination thereof. Note that a STA may transmit interference information to its associated AP as part of a CSR procedure (e.g., joint CSR sounding test) or periodically in order to update the AP.

In certain aspects, the first wireless node may determine whether to make a TXOP a shared TXOP based on an SIR from neighboring BSSs observed by a third wireless node (e.g., STA) served by the first wireless node. For example, the first wireless node may determine to share a TXOP when the SIR at the third wireless node satisfies one or more conditions (e.g., the SIR is greater than a threshold). Note that the threshold may be a fixed value or may depend on other parameters, such as SNR at the third wireless node, intended MCS for the third wireless node, etc.

Note that while FIG. 3 depicts including information indicating that a TXOP is a shared TXOP within a dedicated frame, such as frame 312, in other aspects, such information may be included as part of a different frame (e.g., part of a RTS/CTS exchange, such as the RTS/CTS exchange depicted in FIG. 3) and/or combined with other frames described and depicted in FIG. 3.

As indicated at 380, assuming the first wireless node is a sharing AP, the first wireless node may generate and transmit a frame 314 indicating one or more shared APs for a shared TXOP, which can be used for a coordinated transmission. As indicated at 382, the second wireless node may obtain information from frame 314 indicating one or more shared APs for a shared TXOP, which can be used for a coordinated transmission. In certain aspects, the first wireless node may generate and transmit the frame 314 on an ad-hoc basis, for example, without performing a negotiation with other wireless nodes. In other aspects, the first wireless node may generate and transmit the frame as part of a negotiation with one or more wireless nodes, such as the negotiation indicated at 340.

In some aspects, the first wireless node may select a group of wireless nodes to be shared APs for a shared TXOP based on a pre-existing agreement. For example, a group of wireless nodes may have previously agreed to share TXOPs with each other or may have formed a CSR group (e.g., during negotiation at 340). In such an example, when a wireless node in the group of wireless node announces that its TXOP will be a shared TXOP, other wireless nodes within the group may be selected as shared APs for that shared TXOP. In some cases, the CSR group may be extended to include AP-STA pairs in addition to APs. In one reference example, two APs (e.g., AP1 and AP2) may form a CSR group and share their respective TXOPs with each other. In another reference example, a first AP-STA pair (e.g., AP1-STA1) and a second AP-STA pair (e.g., AP2-STA2) may form a CSR group. In this example, when AP1 is serving STA1, AP2 may become a shared AP and may transmit to STA2 but may not transmit to other STAs that are associated with AP2.

In some aspects, the first wireless node may select a group of wireless nodes to be shared APs for a shared TXOP based on an expected interference level. For example, the first wireless node may select which wireless nodes may become shared APs based on the expected interference from different BSSs. The expected interference level may be based on historical measurement or based on recent feedback from wireless nodes (e.g., STAs, APs, or a combination thereof) in the different BSSs.

In some aspects, the first wireless node may select a group of wireless nodes to be shared APs for a shared TXOP based on a total SIR across BSSs. For example, the first wireless node may select which wireless nodes may become shared APs based on the sum SIR between different BSSs and their respective intended serving STAs.

In some aspects, the first wireless node may select a group of wireless nodes to be shared APs for a shared TXOP based on the maximum total interference at serving STAs from different BSSs. For example, each serving STA may be subjected to interference from different BSSs and may sum the interference from the different BSSs to obtain a total amount of interference from different BSSs. The first wireless node may obtain an indication of the total interference (e.g., SNR/SINR) at STAs being served by different wireless nodes and may select the group of wireless nodes based on the maximum total interference among the serving STAs of the first wireless node.

In some aspects, the first wireless node may select a group of wireless nodes to be shared APs for a shared TXOP based on the deployment of wireless nodes in an environment. For instance, if 4 APs are deployed in a square layout, the first wireless node may determine that the diagonal AP(s) are shared APs. In another example, the first wireless node may select the group of wireless nodes based on a respective distance between the first wireless node and each of the other wireless nodes.

In some aspects, the first wireless node may select a group of wireless nodes to be shared APs for a shared TXOP based on a prior TXOP sharing agreement. For example, the first wireless node may select a given wireless node to be a shared AP if the first wireless node has shared its TXOP with that wireless node in the past. For instance, assuming AP1 has shared its TXOP with AP2 at a first point in time, when AP2 becomes the TXOP holder at a second subsequent point in time, AP2 may prioritize selecting AP1 to be its shared AP over other APs.

In some aspects, the first wireless node may select a group of wireless nodes to be shared APs for a shared TXOP randomly from a pool of potential shared APs (e.g., candidate wireless nodes) or in a round-robin fashion.

Note that while FIG. 3 depicts including information indicating a set of shared APs for a shared TXOP within a dedicated frame, such as frame 314, in other aspects, such information may be included as part of a different frame (e.g., part of a RTS/CTS exchange, such as the RTS/CTS exchange depicted in FIG. 3) and/or combined with other frames described and depicted in FIG. 3.

As indicated at 390, assuming the first wireless node is a sharing AP, the first wireless node may generate a frame 316 that includes one or more parameters indicating a constraint on communication during a shared TXOP used for a coordinated transmission. As indicated at 392, the second wireless node may obtain one or more parameters from frame 316 indicating a constraint on communication during a shared TXOP used for a coordinated transmission. For example, the parameters may include an interference tolerance level of the first wireless node, a maximum transmit power allowed at the second wireless node (e.g., shared AP), or a combination thereof.

In certain aspects, the parameters within the frame 316 may indicate constraints on communication in terms of throughput (e.g., throughput-based parameters). One reference example of such a parameter may include a throughput degradation value (or throughput degradation threshold or throughput degradation limit). For instance, the throughput degradation value may specify an amount of allowed throughput degradation that can occur during a coordinated transmission. Throughput degradation may occur as a result of lowered MCS due to SR interference, increased packet error rate, lowered SINR level, or a combination thereof. The throughput degradation value may be specified in terms of a certain percentage, a limit on MCS level, a limit on spatial streams reduction, or an SINR reduction limit, as illustrative, non-limiting examples.

Another reference example of such a throughput-based parameter may include an interference tolerance value (or interference tolerance threshold or interference tolerance limit). For instance, the interference tolerance value may be a certain amount of interference that can be allowed by the sharing AP during a coordinated transmission. That is, the shared APs may transmit so long as the (combined) interference detected at the primary receiver is lower than the amount of interference indicated by the interference tolerance value. In certain aspects, the interference tolerance value may be used for TB-based transmissions (e.g., where the number of shared APs may be known) and non-TB transmissions (e.g., where the number of shared APs may not be known).

Another reference example of such a throughput-based parameter may include a per-STA aggregated throughput over a certain period of time. The per-STA aggregated throughput may be a certain amount of throughput that should be guaranteed to a STA in a sharing BSS or a shared BSS, aggregated over a period of time during which the STA may be served for part of the period of time when its serving AP is a sharing AP, served for another part of the period of time when its serving AP is a shared AP, and not served for the remaining of the period of time. In certain aspects, the per-STA aggregated throughput may be specified in the form of a minimum throughput, a median throughput, certain percentile STA performance (e.g., 10^{th} percentile STA performance), outage probability, etc. In certain aspects, the per-STA aggregated throughput may be specified in the form of a degradation percentage (e.g., only 10% of the STAs can suffer 5% or more of its throughput when compared to a non-coordinated transmission).

In certain aspects, the parameters within the frame 316 may indicate constraints on communication in terms of transmit power (e.g., transmit power-based parameters). One reference example of such a parameter may include a TXOP holder transmit power guarantee. With this parameter, the TXOP holder may be guaranteed to transmit at a target transmit power (e.g., maximum transmit power). Non-TXOP holders (e.g., shared APs) may also be able to transmit at the target transmit power, but may not be guaranteed to transmit at the target transmit power. The power control of the shared APs can be based on one or more criteria (e.g., sum throughput maximization, satisfying the tolerable interference level in the sharing BSS, etc.).

Another reference example of such a transmit power-based parameter may include a target transmit power value for each of the shared APs, where the target transmit power value for each shared AP corresponds to a respective overlapping bandwidth between the sharing AP and the shared AP. In certain cases, for example, the sharing AP and one or more of the shared APs may operate in different channels. Consider an example scenario in which a sharing AP and a shared AP each operate in a 320 MHz channel and 160 MHz portion of the 320 MHz channel is overlapped between the sharing AP and shared AP. In this scenario, when the sharing AP shares its TXOP with the shared AP, the shared AP may transmit in the overlapping 160 MHz portion, but may or may not be able to transmit in the non-overlapping 160 MHz portion. Because the transmit power is generally specified over the entire bandwidth (e.g., 320 MHz channel in this scenario), the sharing AP may indicate, for each shared AP, the target transmit power value for the overlapped portion of bandwidth between the sharing AP and the shared AP. That is, the target transmit power value may be applicable for the overlapping bandwidth between the shared AP and sharing AP and may not be applicable for non-overlapping bandwidth between the shared AP and sharing AP.

In some cases, the target transmit power value associated with the overlapping bandwidth may be defined as (i) a total power target (summed across the tones in the overlapping bandwidth) or (ii) a power normalized to a given portion of the overlapping bandwidth (e.g., 20 MHz of an overlapping 160 MHz). In one reference example, if the normalized power target (Ptargetₙₒᵣₘ) is associated with 20 MHz, and the overlapping bandwidth between the sharing AP and shared AP is 160 MHZ, then the shared AP may be able to transmit with a transmission power up to 8*Ptargetₙₒᵣₘ in the 160 MHz overlapping bandwidth.

In certain aspects, the parameters within the frame 316 may indicate constraints on communication in terms of delay (e.g., delay-based parameters). With this parameter, there may be a limit on the delay for each STA in a sharing BSS. The per-STA delay-based parameter may be specified in the form of a maximum delay, a median delay, certain percentile STA performance (e.g., 90^{th} percentile STA performance), etc. In certain aspects, the per-STA delay-based parameter may be specified in the form of a degradation percentage (e.g., the maximum delay for 90% of the STAs may not be increased by 5% or more when compared to a non-coordinated transmission).

Note that while FIG. 3 depicts including parameters indicating a constraint on communication during a shared TXOP within a dedicated frame, such as frame 316, in other aspects, such information may be included as part of a different frame (e.g., part of a RTS/CTS exchange, such as the RTS/CTS exchange depicted in FIG. 3) and/or combined with other frames described and depicted in FIG. 3. For example, such parameters may be negotiated among one or more wireless nodes using a procedure, such as the negotiation indicated at 340. In certain aspects, the parameters indicating a constraint on communication may be in the form of one or more rules specified in a wireless communication standard. In certain aspects, the parameters may be updated periodically and/or dynamically changed.

According to certain aspects, the techniques described herein may be used to promote TXOP sharing by providing wireless nodes with an incentive each time a TXOP is shared. For example, if a BSS has shared its TXOP, then it may be allowed to have a shorter contention window in a subsequent transmission to improve the likelihood of winning the channel access. In another example, a shared BSS may have to share its TXOP back to the sharing BSS.

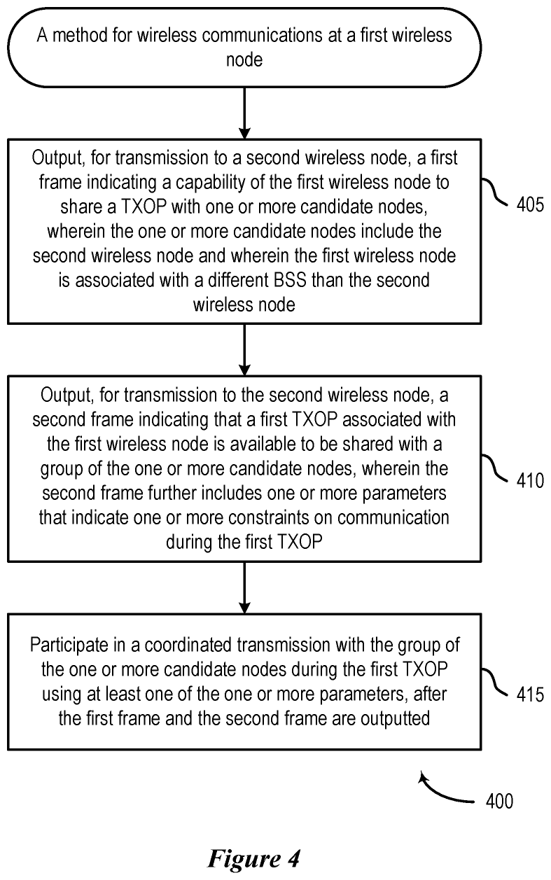

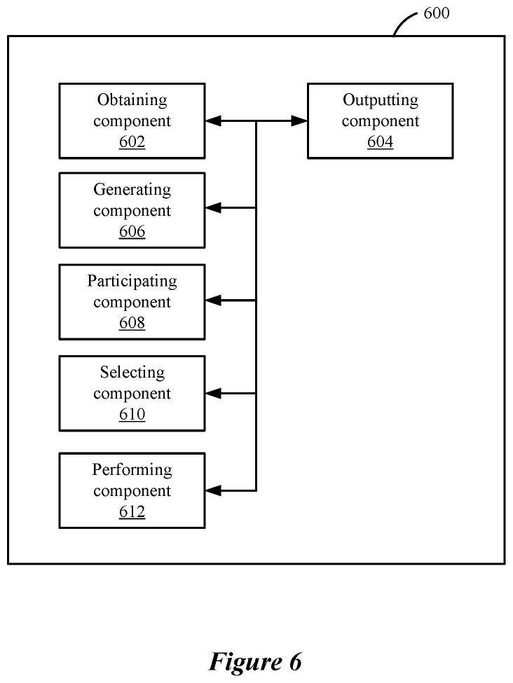

FIG. 4 shows a flowchart illustrating an example process 400 performable at a first wireless node, according to certain aspects of the present disclosure. The operations of the process 400 may be implemented by a wireless AP or its components, such as one of the wireless APs 102 described with reference to FIG. 1. For example, the process 400 may be performed by a wireless communication device, such as the wireless communication device 600 described with reference to FIG. 6, operating as or within a wireless AP. In some examples, the process 400 may be performed by a wireless AP that is a sharing AP (associated with a sharing BSS).

Process 400 begins at step 405 with outputting, for transmission to a second wireless node, a first frame (e.g., frame 304) indicating a capability of the first wireless node to share a TXOP with one or more candidate nodes (e.g., a pool of potential shared APs). The one or more candidate nodes may include the second wireless node. The first wireless node may be associated with a different BSS than each of the one or more candidate nodes.

Process 400 also includes step 410 which involves outputting, for transmission to the second wireless node, a second frame (e.g., frame 312, frame 314, frame 316, or a combination thereof) indicating that a first TXOP associated with the first wireless node is available to be shared with a group of the one or more candidate nodes (e.g. shared APs of a CSR group). The second frame may also include one or more parameters that indicate one or more constraints on communication during the first TXOP.

Process 400 also includes step 415 which involves participating in a coordinated transmission with the group of the one or more candidate nodes (e.g., shared APs of a CSR group) during the first TXOP using at least one of the one or more parameters. The first wireless node may participate in the coordinated transmission after the first frame and second frame are outputted.

In certain aspects, process 400 may also involve obtaining a respective third frame (e.g., frame 302) from each of the one or more candidate nodes indicating a capability of the candidate node to share a TXOP with the first wireless node. In such aspects, the second frame may be outputted after the third frames are obtained.

In certain aspects, the indication of the capability of the first wireless node may include a type of coordination between the first wireless node and the one or more candidate nodes that is supported during the TXOP. In such aspects, the type of coordination may include at least one of: (i) a transmit power coordination, (ii) an interference management coordination, or (iii) a CSI, CQI or interference measurement coordination.

In certain aspects, the second frame may include a respective identifier for each of the one or more candidate nodes of the group.

In certain aspects, the one or more parameters may include at least one of: (i) an interference tolerance value of the first wireless node during the first TXOP, (ii) a respective throughput degradation value for each of the one or more candidate nodes of the group during the first TXOP, (iii) a throughput degradation value over a period of time for a respective one or more third wireless nodes (e.g., STAs) associated with each of the one or more candidate nodes of the group, or (iv) a respective maximum transmit power value for each of the one or more candidate nodes of the group during the first TXOP.

In certain aspects, the one or more parameters may include a respective maximum transmit power value for each of the one or more candidate nodes of the group during the first TXOP. The respective maximum transmit power value for each of the one or more candidate nodes of the group may be associated with a respective overlapping bandwidth of the candidate node and the first wireless node. The respective maximum transmit power value for each of the one or more candidate nodes of the group may include an adjusted transmit power value (e.g., normalized power target, such as Ptargetₙₒᵣₘ) associated with a portion of the respective overlapping bandwidth of the candidate node and the first wireless node.

In certain aspects, the one or more parameters may include a minimum transmit power level of the first wireless node during the first TXOP.

In certain aspects, the one or more parameters may include a respective delay degradation value for a respective one or more third wireless nodes (e.g., STAs) associated with each of the one or more candidate nodes of the group during the first TXOP.

In certain aspects, the process 400 may also involve obtaining an indication of a pre-existing agreement between the first wireless node and the group of the one or more candidate nodes to share the first TXOP. In such aspects, the second frame may be outputted after the indication of the pre-existing agreement is obtained.

In certain aspects, the process 400 may also involve obtaining an indication of at least one of (i) an SNR associated with the apparatus at a second wireless node, (ii) a MCS intended for the second wireless node, (iii) an SINR at the second wireless node, or (iv) an SIR at the second wireless node, where the SIR is associated with at least one of the one or more candidate nodes of the group. In such aspects, the second frame may be outputted after the indication is obtained.

In certain aspects, the process 400 may also involve obtaining an indication of at least one of: (i) a pre-existing agreement between the first wireless node and the group of the one or more candidate nodes, (ii) a respective interference metric associated with each of the one or more candidate nodes of the group, or (iii) a respective distance between the first wireless node and each of the one or more candidate nodes of the group. In such aspects, the process 400 may further involve selecting the group of the one or more candidate nodes after the indication is obtained.

In certain aspects, the process 400 may also involve randomly selecting the group of the one or more candidate nodes and outputting, for transmission to each of the one or more candidate nodes of the group, a third frame (e.g., frame 314, frame 308, or a combination thereof) including an indication of the group of the one or more candidate nodes.

In certain aspects, the process 400 may also involve performing a round robin selection of the group of the one or more candidate nodes and outputting, for transmission to each of the one or more candidate nodes of the group, a third frame (e.g., frame 314, frame 308, or a combination thereof) including an indication of the group of the one or more candidate nodes.

In certain aspects, the process 400 may also involve participating in a negotiation (e.g., negotiation indicated at 340 of FIG. 3) with each of the one or more candidate nodes of the group and selecting the group of the one or more candidate nodes after participating in the negotiation.

In certain aspects, the process 400 may also involve outputting, for transmission to each of the one or more candidate nodes of the group, a third frame (e.g., frame 314, frame 308, or a combination thereof) including an indication of the group of the one or more candidate nodes. In such aspects, the first wireless node may participate in the coordinated transmission after the third frame is outputted.

In certain aspects, process 400, or any aspect related to it, may be performed by an apparatus, such as wireless communication device 600 of FIG. 6, which includes various components operable, configured, or adapted to perform the process 400. Wireless communication device 600 is described below in further detail.

Note that FIG. 4 is just one example of a method, and other methods including fewer, additional, or alternative steps are possible consistent with this disclosure.

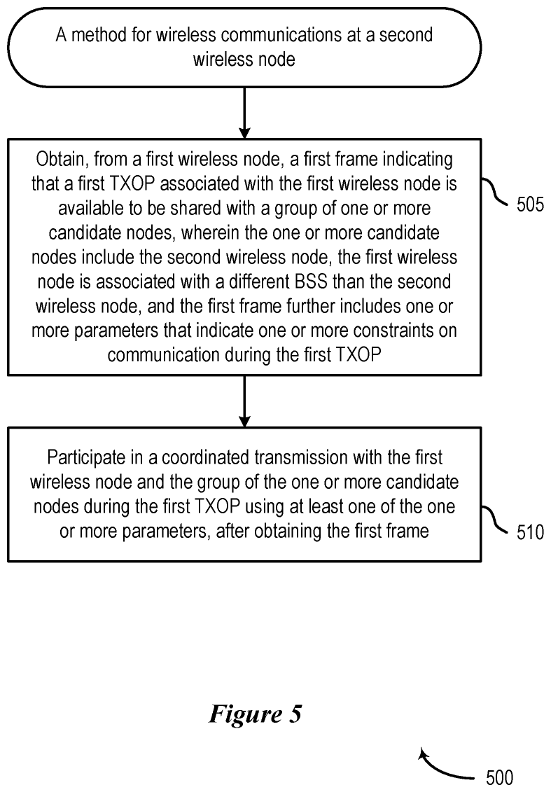

FIG. 5 shows a flowchart illustrating an example process 500 performable at a second wireless node, according to certain aspects of the present disclosure. The operations of the process 500 may be implemented by a wireless AP or its components, such as one of the wireless APs 102 described with reference to FIG. 1. For example, the process 500 may be performed by a wireless communication device, such as the wireless communication device 600 described with reference to FIG. 6, operating as or within a wireless AP. In some examples, the process 500 may be performed by a wireless AP that is a shared AP (associated with a shared BSS).

Process 500 begins at step 505 with obtaining, from a first wireless node, a first frame (e.g., frame 312, frame 314, frame 316, or a combination thereof) indicating that a first TXOP associated with the first wireless node is available to be shared with a group of one or more candidate nodes. The one or more candidate nodes may include the second wireless node. The first wireless node may be associated with a different BSS than the second wireless node. The first frame may further include one or more parameters that indicate one or more constraints on communication during the first TXOP.

Process 500 also includes step 510 which involves participating in a coordinated transmission with the first wireless node and the group of the one or more candidate nodes during the first TXOP using at least one of the one or more parameters, after the first frame has been obtained.

In certain aspects, process 500 may also involve obtaining, from the first wireless node, a second frame (e.g., frame 304) indicating a capability of the first wireless node to share a TXOP with the second wireless node. In such aspects, the indication of the capability of the first wireless node may include a type of coordination between the first wireless node and the second wireless node that is supported during the TXOP. The type of coordination may include at least one of (i) a transmit power coordination, (ii) an interference management coordination, or (iii) a CSI, CQI or interference measurement coordination.

In certain aspects, process 500 may also involve outputting, for transmission to the first wireless node, a second frame (e.g., frame 302) indicating a capability of the second wireless node to share a TXOP with the first wireless node. In such aspects, the first frame may be obtained after the second frame is outputted.

In certain aspects, the one or more parameters may include at least one of (i) an interference tolerance value of the first wireless node during the first TXOP, (ii) a respective throughput degradation value for each of the one or more candidate nodes of the group during the first TXOP, (iii) a throughput degradation value over a period of time for a respective one or more third wireless nodes (e.g., STAs) associated with each of the one or more candidate nodes of the group, or (iv) a respective maximum transmit power value for each of the one or more candidate nodes of the group during the first TXOP.

In certain aspects, the one or more parameters may include a respective maximum transmit power value for each of the one or more candidate nodes of the group during the first TXOP. The respective maximum transmit power value for each of the one or more candidate nodes of the group may be associated with a respective overlapping bandwidth of the candidate node and the first wireless node. The respective maximum transmit power value for each of the one or more candidate nodes of the group may include an adjusted transmit power value (e.g., normalized power target, such as Ptargetₙₒᵣₘ) associated with a portion of the respective overlapping bandwidth of the candidate node and the first wireless node.

In certain aspects, the one or more parameters may include a minimum transmit power level of the first wireless node during the first TXOP.

In certain aspects, the one or more parameters may include a respective delay degradation value for a respective one or more third wireless nodes (e.g., STAs) associated with each of the one or more candidate nodes of the group during the first TXOP.

In certain aspects, process 500 may also involve participating in a negotiation (e.g., negotiation indicated at 340 of FIG. 3) with the first wireless node. In such aspects, the first frame may be obtained after participating in the negotiation.

In certain aspects, process 500 may also involve obtaining, from the first wireless node, a second frame (e.g., frame 308, frame 314, or a combination thereof) including an indication of the group of the one or more candidate nodes. In such aspects, the second wireless node may participate in the coordinated transmission after the second frame is obtained.

In certain aspects, process 500 may also involve participating in a negotiation (e.g., negotiation indicated at 340 of FIG. 3) with the first wireless node. In such aspects, the second frame may be obtained after participating in the negotiation.

In certain aspects, in order to participate in the negotiation, process 500 may involve outputting, for transmission to the first wireless node, at least a third frame (e.g., frame 306) including an indication of at least one of: (i) a pre-existing agreement between the second wireless node and the first wireless node, (ii) an interference metric associated with the second wireless node, or (iii) a distance between the second wireless node and the first wireless node.

In certain aspects, process 500, or any aspect related to it, may be performed by an apparatus, such as wireless communication device 600 of FIG. 6, which includes various components operable, configured, or adapted to perform the process 500. Wireless communication device 600 is described below in further detail.

Note that FIG. 5 is just one example of a method, and other methods including fewer, additional, or alternative steps are possible consistent with this disclosure.

FIG. 6 shows a block diagram of an example wireless communication device 600 that supports techniques disclosed herein, such as techniques that improve CSR operation in a wireless network. In some examples, the wireless communication device 600 is configured to perform the process 400 described with reference to FIG. 4. In some examples, the wireless communication device 600 is configured to perform the process 500 described with reference to FIG. 5. The wireless communication device 600 may include one or more chips, SoCs, chipsets, packages, components or devices that individually or collectively constitute or comprise a processing system. The processing system may interface with other components of the wireless communication device 600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 600 may transmit the information output from the chip. In such an example, the second interface may refer to an interface between the processing system of the chip and a reception component, such that the wireless communication device 600 may receive information that is then passed to the processing system. In some such examples, the first interface also may obtain information, such as from the transmission component, and the second interface also may output information, such as to the reception component.

The processing system of the wireless communication device 600 includes processor (or “processing”) circuitry in the form of one or multiple processors, microprocessors, processing units (such as central processing units (CPUs), graphics processing units (GPUs) or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 600 can be configurable or configured for use in an AP or a STA, such as the AP 102 or the STA 104 described with reference to FIG. 1. In some other examples, the wireless communication device 600 can be an AP or a STA that includes such a processing system and other components including multiple antennas. The wireless communication device 600 is capable of transmitting and receiving wireless communications in the form of, for example, wireless packets. For example, the wireless communication device 600 can be configurable or configured to transmit and receive packets in the form of physical layer PPDUs and MPDUs conforming to one or more of the IEEE 802.11 family of wireless communication protocol standards. In some other examples, the wireless communication device 600 can be configurable or configured to transmit and receive signals and communications conforming to one or more 3GPP specifications including those for 5G NR or 6G. In some examples, the wireless communication device 600 also includes or can be coupled with one or more application processors which may be further coupled with one or more other memories. In some examples, the wireless communication device 600 further includes at least one external network interface coupled with the processing system that enables communication with a core network or backhaul network that enables the wireless communication device 600 to gain access to external networks including the Internet.

The wireless communication device 600 includes an obtaining component 602, an outputting component 604, a generating component 606, a participating component 608, a selecting component 610, and a performing component 612.

Portions of one or more of the components 602, 604, 606, 608, 610, and 612 may be implemented at least in part in hardware or firmware. For example, the obtaining component 602, participating component 608, and/or outputting component 604 may be implemented at least in part by a processor or a modem. In some examples, portions of one or more of the components 602, 604, 606, 608, 610, and 612 may be implemented at least in part by a processor and software in the form of processor-executable code stored in a memory. For example, portions of one or more of the components 602, 604, 606, 608, 610, and 612 can be implemented as non-transitory instructions (or “code”) executable by the processor to perform the functions or operations of the respective module.

In some implementations, the processor may be a component of a processing system. A processing system may generally refer to a system or series of machines or components that receives inputs and processes the inputs to produce a set of outputs (which may be passed to other systems or components of, for example, the wireless communication device 600). For example, a processing system of the wireless communication device 600 may refer to a system including the various other components or subcomponents of the wireless communication device 600, such as the processor, or a transceiver, or a communications manager, or other components or combinations of components of the wireless communication device 600. The processing system of the wireless communication device 600 may interface with other components of the wireless communication device 600, and may process information received from other components (such as inputs or signals) or output information to other components. For example, a chip or modem of the wireless communication device 600 may include a processing system, a first interface to output information and a second interface to obtain information. In some implementations, the first interface may refer to an interface between the processing system of the chip or modem and a transmitter, such that the wireless communication device 600 may transmit information output from the chip or modem. In some implementations, the second interface may refer to an interface between the processing system of the chip or modem and a receiver, such that the wireless communication device 600 may obtain information or signal inputs, and the information may be passed to the processing system. A person having ordinary skill in the art will readily recognize that the first interface also may obtain information or signal inputs, and the second interface also may output information or signal outputs.

Various components of the wireless communication device 600 may provide means for performing the process 400 described with reference to FIG. 4, the process 500 described with reference to FIG. 5, or any aspect related to them. Means for receiving or obtaining may include transceivers and/or antenna(s) of the AP 102 described with reference to FIG. 1 and/or the obtaining component 602 of the wireless communication device 600. Means for transmitting, sending, or outputting for transmission may include transceivers and/or antenna(s) of the AP 102 described with reference to FIG. 1 and/or the outputting component 604 of the wireless communication device 600.

Means for generating may include one or more processors (such as a receive processor, a controller, and/or a transmit processor) of the AP 102 described with reference to FIG. 1 and/or the generating component 606 of the wireless communication device 600. Means for participating may include one or more processors (such as a receive processor, a controller, and/or a transmit processor) of the AP 102 described with reference to FIG. 1 and/or the participating component 608 of the wireless communication device 600. Means for selecting may include one or more processors (such as a receive processor, a controller, and/or a transmit processor) of the AP 102 described with reference to FIG. 1 and/or the selecting component 610 of the wireless communication device 600. Means for performing may include one or more processors (such as a receive processor, a controller, and/or a transmit processor) of the AP 102 described with reference to FIG. 1 and/or the performing component 612 of the wireless communication device 600.

In some cases, rather than actually transmitting, for example, signals and/or data, the wireless communication device 600 may have an interface to output signals and/or data for transmission (means for outputting). For example, a processor may output signals and/or data, via a bus interface, to a radio frequency (RF) front end of the wireless communication device 600 for transmission. In various aspects, the RF front end may include various components, including transmit and receive processors, transmit and receive MIMO processors, modulators, demodulators, and the like.

In some cases, rather than actually receiving signals and/or data, the wireless communication device 600 may have an interface to obtain the signals and/or data received from another device (means for obtaining). For example, a processor may obtain (or receive) the signals and/or data, via a bus interface, from an RF front end of the wireless communication device 600 for reception. In various aspects, the RF front end may include various components, including transmit and receive processors, transmit and receive MIMO processors, modulators, demodulators, and the like.

### Example Clauses

Implementation examples are described in the following numbered clauses:

Clause 1: A method for wireless communication at a first wireless node, comprising: outputting, for transmission to a second wireless node, a first frame indicating a capability of the first wireless node to share a transmission opportunity (TXOP) with one or more candidate nodes, wherein the one or more candidate nodes include the second wireless node and wherein the first wireless node is associated with a different basic service set (BSS) than the second wireless node; outputting, for transmission to the second wireless node, a second frame indicating that a first TXOP associated with the first wireless node is available to be shared with a group of the one or more candidate nodes, wherein the second frame further comprises one or more parameters that indicate one or more constraints on communication during the first TXOP; and after outputting the first frame and the second frame, participating in a coordinated transmission with the group of the one or more candidate nodes during the first TXOP using at least one of the one or more parameters.

Clause 2: The method of Clause 1, further comprising obtaining a respective third frame from each of the one or more candidate nodes indicating a capability of the candidate node to share the TXOP with the first wireless node, wherein the second frame is outputted after the third frames are obtained.

Clause 3: The method according to any of Clauses 1-2, wherein the indication of the capability of the first wireless node comprises a type of coordination between the first wireless node and the one or more candidate nodes that is supported during the TXOP.

Clause 4: The method of Clause 3, wherein the type of coordination comprises at least one of (i) a transmit power coordination, (ii) an interference management coordination, or (iii) a channel state information (CSI), channel quality information (CQI) or interference measurement coordination.

Clause 5: The method according to any of Clauses 1-4, wherein the second frame comprises a respective identifier for each of the one or more candidate nodes of the group.

Clause 6: The method according to any of Clauses 1-5, wherein the one or more parameters comprise at least one of (i) an interference tolerance value of the first wireless node during the first TXOP, (ii) a respective throughput degradation value for each of the one or more candidate nodes of the group during the first TXOP, (iii) a throughput degradation value over a period of time for a respective one or more second wireless nodes associated with each of the one or more candidate nodes of the group, or (iv) a respective transmit power value for each of the one or more candidate nodes of the group during the first TXOP.

Clause 7: The method according to Clause 6, wherein the respective transmit power value for each of the one or more candidate nodes of the group is associated with a respective overlapping bandwidth of the candidate node and the apparatus.

Clause 8: The method according to Clause 7, wherein the respective transmit power value for each of the one or more candidate nodes of the group comprises an adjusted transmit power value associated with a portion of the respective overlapping bandwidth of the candidate node and the apparatus.

Clause 9: The method according to any of Clauses 1-8, wherein the one or more parameters comprise a minimum transmit power level of the first wireless node during the first TXOP.

Clause 10: The method according to any of Clauses 1-9, wherein the one or more parameters comprise a respective delay degradation value for a respective one or more second wireless nodes associated with each of the one or more candidate nodes of the group during the first TXOP.

Clause 11: The method according to any of Clauses 1-10, further comprising obtaining an indication of a pre-existing agreement between the first wireless node and the group of the one or more candidate nodes to share the first TXOP, wherein the second frame is outputted after the indication of the pre-existing agreement is obtained.

Clause 12: The method according to any of Clauses 1-11, further comprising obtaining an indication of at least one of (i) a signal-to-noise ratio (SNR) associated with the first wireless node at a third wireless node, (ii) a modulation and coding scheme (MCS) being used by the third wireless node, (iii) a signal-to-interference-and-noise ratio (SINR) at the third wireless node, or (iv) a signal-to-interference ratio (SIR) at the third wireless node, the SIR being associated with at least one of the one or more candidate nodes of the group, wherein the second frame is outputted after the indication is obtained.

Clause 13: The method according to any of Clauses 1-12, further comprising: obtaining an indication of at least one of: (i) a pre-existing agreement between the first wireless node and the group of the one or more candidate nodes, (ii) a respective interference metric associated with each of the one or more candidate nodes of the group, or (iii) a respective distance between the first wireless node and each of the one or more candidate nodes of the group; and selecting the group of the one or more candidate nodes after the indication is obtained.

Clause 14: The method according to any of Clauses 1-13, further comprising: randomly selecting the group of the one or more candidate nodes or performing a round robin selection of the group of the one or more candidate nodes; and outputting, for transmission to each of the one or more candidate nodes of the group, a third frame comprising an indication of the group of the one or more candidate nodes.

Clause 15: The method according to any of Clauses 1-13, further comprising: participating in a negotiation with each of the one or more candidate nodes of the group; and selecting the group of the one or more candidate nodes after participating in the negotiation.

Clause 16: The method according to any of Clauses 1-15, further comprising outputting, for transmission to each of the one or more candidate nodes of the group, a third frame comprising an indication of the group of the one or more candidate nodes, wherein participating in the negotiation occurs after the third frame is outputted.

Clause 17: The method according to any of Clauses 1-16, wherein the first wireless node includes at least one transceiver configured to transmit the first frame and the second frame, wherein the first wireless node is configured as an access point.

Clause 18: A method for wireless communication at a first wireless node, comprising: obtaining, from a second wireless node, a first frame indicating that a first transmission opportunity (TXOP) associated with the second wireless node is available to be shared with a group of one or more candidate nodes, wherein the one or more candidate nodes include the first wireless node, wherein the first wireless node is associated with different basic service set (BSS) than the second wireless node, and wherein the first frame further comprises one or more parameters that indicate one or more constraints on communication during the first TXOP; and after obtaining the first frame, participating in a coordinated transmission with the first wireless node and the group of the one or more candidate nodes during the first TXOP using at least one of the one or more parameters.

Clause 19: The method of Clause 18, further comprising obtaining, from the second wireless node, a second frame indicating a capability of the second wireless node to share a TXOP with the first wireless node.

Clause 20: The method of Clause 19, wherein the indication of the capability of the second wireless node comprises a type of coordination between the second wireless node and the first wireless node that is supported during the TXOP.

Clause 21: The method of Clause 20, wherein the type of coordination comprises at least one of (i) a transmit power coordination, (ii) an interference management coordination, or (iii) a channel state information (CSI), channel quality information (CQI) or interference measurement coordination.

Clause 22: The method according to any of Clauses 18-21, further comprising outputting, for transmission to the second wireless node, a second frame indicating a capability of the first wireless node to share a TXOP with the second wireless node, wherein the first frame is obtained after the second frame is outputted.

Clause 23: The method according to any of Clauses 18-22, wherein the one or more parameters comprise at least one of (i) an interference tolerance value of the second wireless node during the first TXOP, (ii) a respective throughput degradation value for each of the one or more candidate nodes of the group during the first TXOP, (iii) a throughput degradation value over a period of time for a respective one or more third wireless nodes associated with each of the one or more candidate nodes of the group, or (iv) a respective transmit power value for each of the one or more candidate nodes of the group during the first TXOP.

Clause 24: The method according to Clause 23, wherein the respective transmit power value for each of the one or more candidate nodes of the group is associated with a respective overlapping bandwidth of the candidate node and the apparatus.

Clause 25: The method according to Clause 24, wherein the respective transmit power value for each of the one or more candidate nodes of the group comprises an adjusted transmit power value associated with a portion of the respective overlapping bandwidth of the candidate node and the apparatus.

Clause 26: The method according to any of Clauses 18-25, wherein the one or more parameters comprise a minimum transmit power level of the second wireless node during the first TXOP.

Clause 27: The method according to any of Clauses 18-26, wherein the one or more parameters comprise a respective delay degradation value for a respective one or more third wireless nodes associated with each of the one or more candidate nodes of the group during the first TXOP.

Clause 28: The method according to any of Clauses 18-27, further comprising participating in a negotiation with the second wireless node, wherein the first frame is obtained after participating in the negotiation.

Clause 29: The method according to any of Clauses 18-28, further comprising obtaining, from the second wireless node, a second frame comprising an indication of the group of the one or more candidate nodes, wherein participating in the coordinated transmission occurs after the second frame is obtained.

Clause 30: The method of Clause 29, further comprising participating in a negotiation with the second wireless node, wherein the second frame is obtained after participating in the negotiation.

Clause 31: The method of Clause 30, wherein participating in the negotiation comprises outputting, for transmission to the second wireless node, at least a third frame comprising an indication of at least one of: (i) a pre-existing agreement between the first wireless node and the second wireless node, (ii) an interference metric associated with the first wireless node, or (iii) a distance between the first wireless node and the second wireless node.

Clause 32: The method according to any of Clauses 18-31, wherein the first wireless node includes at least one transceiver configured to receive the first frame, wherein the first wireless node is configured as an access point.

Clause 33: An apparatus, comprising: memory comprising instructions; and at least one processor configured to execute the instructions and cause the apparatus to perform a method in accordance with any one of Clauses 1-32.

Clause 34: An apparatus, comprising means for performing a method in accordance with any one of Clauses 1-32.

Clause 35: A non-transitory computer-readable medium comprising executable instructions that, when executed by at least one processor of an apparatus, cause the apparatus to perform a method in accordance with any one of Clauses 1-32.

Clause 36: A computer program product embodied on a computer-readable storage medium comprising code for performing a method in accordance with any one of Clauses 1-32.

Clause 37: An access point comprising: at least one transceiver, memory comprising instructions; and at least one processor configured to execute the instructions and cause the access point to perform a method in accordance with any one of Clauses 1-16, wherein the at least one transceiver is configured to transmit the first frame and the second frame.

Clause 38: An access point comprising: at least one transceiver, a memory comprising instructions; and at least one processor configured to execute the instructions and cause the access point to perform a method in accordance with any one of Clauses 18-31, wherein the at least one transceiver is configured to receive the first frame.

### Additional Considerations

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,”’ may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising:
memory comprising instructions; and
at least one processor configured to execute the instructions to cause the apparatus to:
output, for transmission to a first wireless node in a first basic service set (BSS), a first frame indicating a capability of the apparatus to share a transmission opportunity (TXOP) with one or more candidate nodes, wherein the one or more candidate nodes include the first wireless node and wherein the apparatus is associated with a second BSS different from the first BSS;
output, for transmission to the first wireless node, a second frame indicating that a first TXOP associated with the apparatus is available to be shared with a group of the one or more candidate nodes, wherein the second frame further comprises one or more parameters that indicate one or more constraints on communication during the first TXOP; and
after the first frame and the second frame are outputted, participate in a coordinated transmission with the group of the one or more candidate nodes during the first TXOP using at least one of the one or more parameters.

2. The apparatus of claim 1, wherein:
the at least one processor is further configured to cause the apparatus to obtain a respective third frame from each of the one or more candidate nodes indicating a capability of the candidate node to share the TXOP with the apparatus; and
the second frame is outputted after the third frames are obtained.

3. The apparatus of claim 1, wherein the indication of the capability of the apparatus comprises a type of coordination between the apparatus and the one or more candidate nodes that is supported during the TXOP.

4. The apparatus of claim 3, wherein the type of coordination comprises at least one of (i) a transmit power coordination, (ii) an interference management coordination, or (iii) a channel state information (CSI), channel quality information (CQI) or interference measurement coordination.

5. The apparatus of claim 1, wherein the second frame comprises a respective identifier for each of the one or more candidate nodes of the group.

6. The apparatus of claim 1, wherein the one or more parameters comprise at least one of (i) an interference tolerance value of the apparatus during the first TXOP, (ii) a respective throughput degradation value for each of the one or more candidate nodes of the group during the first TXOP, (iii) a throughput degradation value over a period of time for a respective one or more second wireless nodes associated with each of the one or more candidate nodes of the group, or (iv) a respective transmit power value for each of the one or more candidate nodes of the group during the first TXOP.

7. The apparatus of claim 6, wherein the respective transmit power value for each of the one or more candidate nodes of the group is associated with a respective overlapping bandwidth of the candidate node and the apparatus.

8. The apparatus of claim 7, wherein the respective transmit power value for each of the one or more candidate nodes of the group comprises an adjusted transmit power value associated with a portion of the respective overlapping bandwidth of the candidate node and the apparatus.

9. The apparatus of claim 1, wherein at least one of:
the one or more parameters comprise a minimum transmit power level of the apparatus during the first TXOP; or.
the one or more parameters comprise a respective delay degradation value for a respective one or more second wireless nodes associated with each of the one or more candidate nodes of the group during the first TXOP.

10. The apparatus of claim 1, wherein at least one of:
(i) the at least one processor is further configured to cause the apparatus to obtain a first indication of a pre-existing agreement between the apparatus and the group of the one or more candidate nodes to share the first TXOP; and the second frame is outputted after the first indication of the pre-existing agreement is obtained; or
(ii) the at least one processor is further configured to cause the apparatus to obtain a second indication of at least one of (i) a signal-to-noise ratio (SNR) associated with the apparatus at a second wireless node, (ii) a modulation and coding scheme (MCS) being used by the second wireless node, (iii) a signal-to-interference-and-noise ratio (SINR) at the second wireless node, or (iv) a signal-to-interference ratio (SIR) at the second wireless node, the SIR being associated with at least one of the one or more candidate nodes of the group; and the second frame is outputted after the second indication is obtained.

11. The apparatus of claim 1, wherein the at least one processor is further configured to cause the apparatus to:
obtain an indication of at least one of: (i) a pre-existing agreement between the apparatus and the group of the one or more candidate nodes, (ii) a respective interference metric associated with each of the one or more candidate nodes of the group, or (iii) a respective distance between the apparatus and each of the one or more candidate nodes of the group; and
select the group of the one or more candidate nodes after the indication is obtained.

12. The apparatus of claim 1, wherein the at least one processor is further configured to cause the apparatus to:
randomly select the group of the one or more candidate nodes or perform a round robin selection of the group of the one or more candidate nodes; and
output, for transmission to each of the one or more candidate nodes of the group, a third frame comprising an indication of the group of the one or more candidate nodes.

13. The apparatus of claim 1, wherein the at least one processor is further configured to cause the apparatus to:
participate in a negotiation with each of the one or more candidate nodes of the group; and
select the group of the one or more candidate nodes after participating in the negotiation.

14. The apparatus of claim 1, wherein:
the at least one processor is further configured to cause the apparatus to output, for transmission to each of the one or more candidate nodes of the group, a third frame comprising an indication of the group of the one or more candidate nodes; and
the apparatus participates in the coordinated transmission after the third frame is outputted.

15. The apparatus of claim 1, further comprising at least one transceiver configured to transmit the first frame and the second frame, wherein the apparatus is configured as an access point.

16. An apparatus for wireless communication, comprising:
memory comprising instructions; and
at least one processor configured to execute the instructions to cause the apparatus to:
obtain, from a first wireless node in a first basic service set (BSS), a first frame indicating that a first transmission opportunity (TXOP) associated with the first wireless node is available to be shared with a group of one or more candidate nodes, wherein the one or more candidate nodes include the apparatus, wherein the apparatus is associated with a second BSS different from the first BSS, and wherein the first frame further comprises one or more parameters that indicate one or more constraints on communication during the first TXOP; and
after the first frame has been obtained, participate in a coordinated transmission with the first wireless node and the group of the one or more candidate nodes during the first TXOP using at least one of the one or more parameters.

17. The apparatus of claim 16, wherein the at least one processor is further configured to cause the apparatus to obtain, from the first wireless node, a second frame indicating a capability of the first wireless node to share a TXOP with the apparatus.

18. The apparatus of claim 17, wherein the indication of the capability of the first wireless node comprises a type of coordination between the first wireless node and the apparatus that is supported during the TXOP.

19. The apparatus of claim 18, wherein the type of coordination comprises at least one of (i) a transmit power coordination, (ii) an interference management coordination, or (iii) a channel state information (CSI), channel quality information (CQI) or interference measurement coordination.

20. The apparatus of claim 16, wherein:
the at least one processor is further configured to cause the apparatus to output, for transmission to the first wireless node, a second frame indicating a capability of the apparatus to share a TXOP with the first wireless node; and
the first frame is obtained after the second frame is outputted.

21. The apparatus of claim 16, wherein the one or more parameters comprise at least one of (i) an interference tolerance value of the first wireless node during the first TXOP, (ii) a respective throughput degradation value for each of the one or more candidate nodes of the group during the first TXOP, (iii) a throughput degradation value over a period of time for a respective one or more second wireless nodes associated with each of the one or more candidate nodes of the group, or (iv) a respective transmit power value for each of the one or more candidate nodes of the group during the first TXOP.

22. The apparatus of claim 21, wherein the respective transmit power value for each of the one or more candidate nodes of the group is associated with a respective overlapping bandwidth of the candidate node and the apparatus.

23. The apparatus of claim 22, wherein the respective transmit power value for each of the one or more candidate nodes of the group comprises an adjusted transmit power value associated with a portion of the respective overlapping bandwidth of the candidate node and the apparatus.

24. The apparatus of claim 16, wherein at least one of:
the one or more parameters comprise a minimum transmit power level of the first wireless node during the first TXOP; or
the one or more parameters comprise a respective delay degradation value for a respective one or more second wireless nodes associated with each of the one or more candidate nodes of the group during the first TXOP.

25. The apparatus of claim 16, wherein:
the at least one processor is further configured to cause the apparatus to participate in a negotiation with the first wireless node; and
the first frame is obtained after participating in the negotiation.

26. The apparatus of claim 16, wherein:
the at least one processor is further configured to cause the apparatus to obtain, from the first wireless node, a second frame comprising an indication of the group of the one or more candidate nodes; and
the apparatus participates in the coordinated transmission after the second frame is obtained.

27. The apparatus of claim 26, wherein:
the at least one processor is further configured to cause the apparatus to participate in a negotiation with the first wireless node; and
the second frame is obtained after participating in the negotiation.

28. The apparatus of claim 27, wherein, in order to participate in the negotiation, the at least one processor is further configured to cause the apparatus to output, for transmission to the first wireless node, at least a third frame comprising an indication of at least one of: (i) a pre-existing agreement between the apparatus and the first wireless node, (ii) an interference metric associated with the apparatus, or (iii) a distance between the apparatus and the first wireless node.

29. The apparatus of claim 16, further comprising at least one transceiver configured to receive the first frame, wherein the apparatus is configured as an access point.

30. A method for wireless communication at a first wireless node, comprising:
outputting, for transmission to a second wireless node, a first frame indicating a capability of the first wireless node to share a transmission opportunity (TXOP) with one or more candidate nodes, wherein the one or more candidate nodes include the second wireless node and wherein the first wireless node is associated with a different basic service set (BSS) than the second wireless node;
outputting, for transmission to the second wireless node, a second frame indicating that a first TXOP associated with the first wireless node is available to be shared with a group of the one or more candidate nodes, wherein the second frame further comprises one or more parameters that indicate one or more constraints on communication during the first TXOP; and
after outputting the first frame and the second frame, participating in a coordinated transmission with the group of the one or more candidate nodes during the first TXOP using at least one of the one or more parameters.
